(19) United States
(12) Patent Application Publication
(10) Pub. No.: US 2003/0179870 A1
(43) Pub. Date: Sep. 25, 2003

(54) Method for automatically generating a business proposal from an accessible electronic database

(76) Inventors: Hilaire deSa, Pelham, AL (US); Heather M. Bruner, Birmingham, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 10/105,902

(22) Filed: Mar. 25, 2002

(51) Int. Cl. H04M 11/00

(52) U.S. Cl. 379/93.12

(57) ABSTRACT

A method for automatically generating a business proposal has been developed. The method includes first identifying a prospective customer to a computer system. Next a service profile for the prospective customer is downloaded with the computer system. The service profile is maintained in a database by a service provider who either currently provides service to the prospective customer or previously provided service to the prospective customer. Finally, the computer system generates a business proposal based on the downloaded service profile.

### BACKGROUND OF INVENTION

1. Field of the Invention

The invention relates generally to a method of doing business. More particularly, the invention relates to a method for automatically generating a business proposal from an accessible electronic database.

2. Background Art

Traditionally, services such as telephone, electricity, and other basic utilities were provided by companies and other organizations that operated as a monopoly while under some form a government regulation. However, recent deregulation has required these monopolies to open up their markets to competition from other parties. As these monopolies are required to open up to an increasingly de-regulated free market, numerous competitors have emerged. A need exists for these competitors to obtain and evaluate existing customer data in order to compete for business.

### SUMMARY OF INVENTION

In some embodiments, the invention relates to a method for generating a business proposal, comprising: identifying a prospective customer to a computer system; downloading a service profile for the prospective customer with the computer system, where the service profile is maintained in a database by the previous service provider; and generating a business proposal based on the service profile.

In other embodiments, the invention relates to a method for generating a business proposal, comprising: step of requesting a proposal for a prospective customer; step of acquiring existing service data for the prospective customer; and step of generating a business proposal for the prospective customer based on the existing service data.

In other embodiments, the invention relates to a method for automatically generating a sales proposal for telephone service, comprising: accessing a computer server; identifying a prospective customer to the computer server with the prospective customer's existing billing telephone number; downloading a customer service record for the prospective customer via a secure point-to-point internet link from a semi-public database that is maintained by the prospective customer's existing telephone service provider; and generating a sales proposal for an identical telephone service that is described in the customer service record.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a schematic diagram of one embodiment of the present invention.

FIG. 2 shows a flow chart of one embodiment of the present invention.

FIG. 3 shows a copy of a business proposal generated by one embodiment of the present invention.

### DETAILED DESCRIPTION

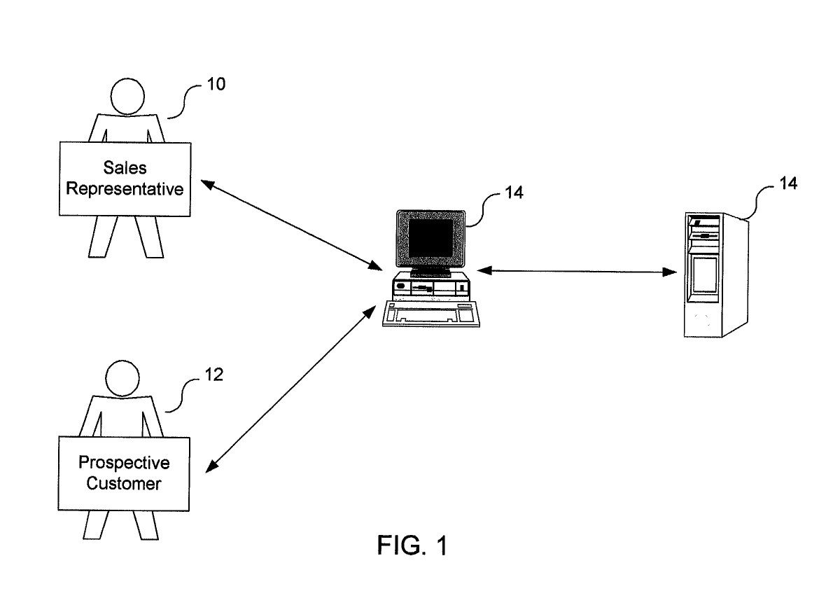

A method for automatically generating a business proposal from an accessible electronic database has been developed. FIG. 1 shows a schematic diagram of one embodiment of the present invention. In the schematic, a sales representative 10 accesses the computer system 14 and submits a request for a business proposal for a prospective customer 12. The computer system 14 then downloads the customer data from an existing customer database 16 that is maintained by the existing or previous service provider. The computer system 14 then generates a business proposal for the identical customer services and sends the proposal to the prospective customer 12.

In this embodiment, the service is local and long-distance telephone service. Under laws such as the “Telecommunications Act of 1996” that are designed to promote competition and customer choice, the existing service provider is required to give access to their customer databases that maintain a list of customers and the features that are provided to them. These service providers are typically large regional telephone companies and the customer data is typically maintained on an electronic database. The law requires that this database be made accessible to competitors. The access to the database is generally “semi-public” in that while it is open and accessible to competitors, they must register or coordinate with the service provider who maintains the database to get access to the customer information. It is important to note that the customer database may contain data on existing customers as well as data on former customers who have since changed service providers. For the sake of convenience, the terms “existing” and “previous” when used in the context of describing either customers or service records shall be used interchangeably. It is the data contained with the database that is the focus, not the current status of the prospective customer's relationship with the service provider who is maintaining the database.

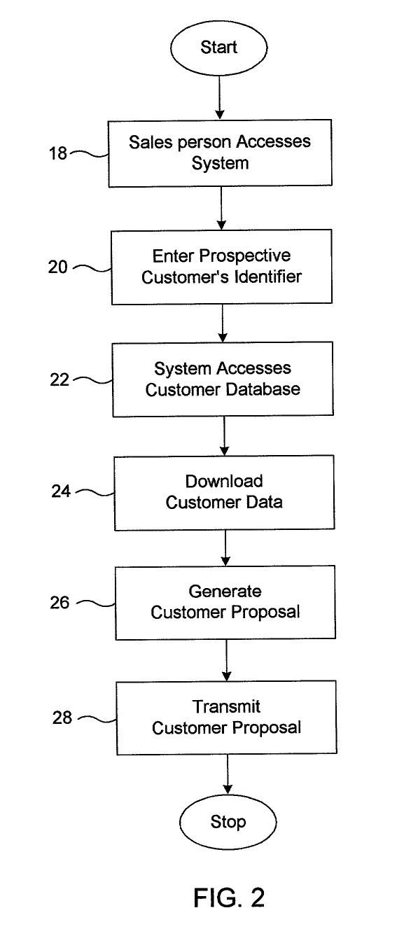

FIG. 2 shows a flow chart of one embodiment of the present invention. In the first step, the sales representative accesses a computer system 18 and enters a customer identifier of the prospect 20. In this embodiment, the identifier may be a billing telephone number (BTN). In alternative embodiments, the identifier could be an account number, a personal identification number (PIN), a password, or other suitable identification that is well known in the art. In alternative embodiments, the prospective customer could submit the request directly to the computer system 22. Next, the computer system 22 accesses the customer database that is maintained by the existing telephone service provider. In this embodiment, the computer system includes a server that contacts the database via a secure point-to-point link over the internet. In this embodiment, the computer system interacts with the service provider through existing software packages that are well known in the art such as the TRS System from Concretio. In an alternative embodiment, contact is made with the database via a dedicated transmission control protocol/internet protocol (TCP/IP) link over the internet. In alternative embodiments, other suitable communications techniques could be used such as direct-dial access to the database. The customer data is identified and then downloaded 24 to the computer system. The customer data is typically called customer service record (CSR) or customer proprietary network information (CPNI). It includes such information as: the number of telephone lines; the long distance service provider; a log of call usage; and a list of additional features such as voicemail, caller ID, etc. that are provided to the customer.

Once the customer data is downloaded 24, the computer system generates a business proposal for the prospective customer 26. In the present embodiment, the proposal generates a cost estimate for each of the services presently provided to the prospective customer. The information for these services is obtained from the CSR. Finally, the proposal is transmitted to the prospective customer 28. In the present embodiment, the proposal is transmitted via facsimile. However in alternative embodiments, the proposal could be transmitted via e-mail or downloaded by the prospective customer via the internet. In other embodiments, the proposal could be sent back to the sales representative instead of directly to the prospective customer. In still other embodiments, the proposal could include the ability of the prospective customer to accept the proposal as written and order the services offered.

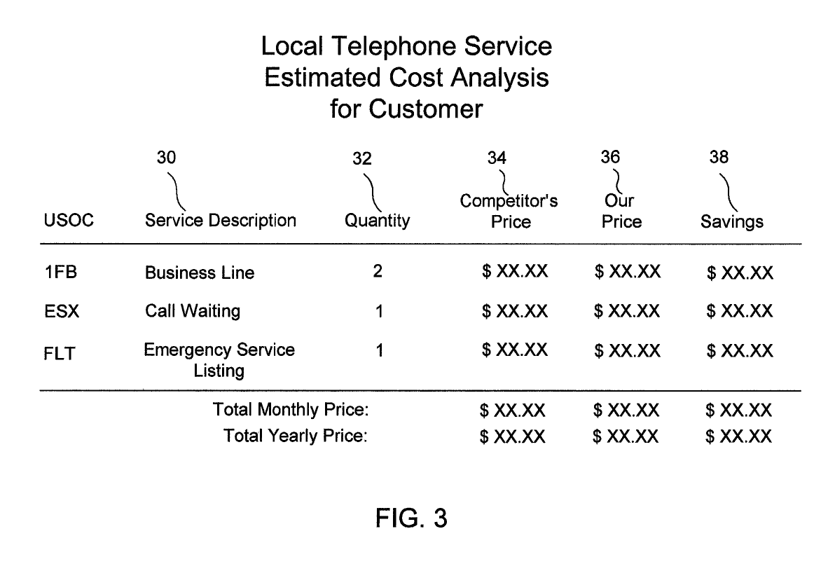

FIG. 3 shows a copy of a business proposal generated by one embodiment of the present invention. In this embodiment, the proposal includes a list and number of the present services used by the customer 30 and 32. This information is retrieved from the CSR. The proposal also includes comparison listings of costs of the current provider's services 34 and the proposed cost 36 to the customer. Additionally, the savings to the customer 38 is also shown. It should be apparent that other arrangements of the information and other content could be used in alternative embodiments. In some alternative embodiments, features not presently provided to the prospective customer could be added or deleted from the proposal at the request of the salesperson or the prospect. Additions and deletions of the features could also be done on the basis of availability or feasibility for the customer. Consequently, the proposal to the prospective customer could be based on only part of the CSR in some embodiments.

While the embodiments discussed have been directed towards telephone service, it should be clear that the present invention could be applied to other services as well. In alternative embodiments, the present invention could be used to generate proposals for utility services such as: electricity; cable television; natural gas; internet service; water; garbage; etc.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A method for generating a business proposal, comprising:
identifying a prospective customer to a computer system;
downloading a service profile for the prospective customer with the computer system, where the service profile is maintained in a database by the previous service provider; and
generating a business proposal based on the service profile.

2. The method of claim 1, further comprising:
transmitting the business proposal to the prospective customer.

3. The method of claim 2, where the business proposal is transmitted by the internet.

4. The method of claim 2, where the business proposal is transmitted by electronic mail.

5. The method of claim 1, where the prospective customer is identified to the computer system by a sales representative.

6. The method of claim 1, where the business proposal is for telephone service.

7. The method of claim 6, where the prospective customer is identified to the computer system by a billing telephone number.

8. The method of claim 1, where the business proposal is for utility service.

9. The method of claim 8, where the utility service is electricity.

10. The method of claim 8, where the utility service is cable television.

11. The method of claim 8, where the utility service is natural gas.

12. The method of claim 8, where the utility service is internet access.

13. The method of claim 1, where the database is accessed by the computer via an internet connection.

14. The method of claim 13, wherein the internet connection is a secure point-to-point link.

15. A method for generating a business proposal, comprising:
step of requesting a proposal for a prospective customer;
step of acquiring existing service data for the prospective customer; and
step of generating a business proposal for the prospective customer based on the existing service data.

16. A method for automatically generating a sales proposal for telephone service, comprising:
accessing a computer server;
identifying a prospective customer to the computer server with the prospective customer's existing billing telephone number;
downloading a customer service record for the prospective customer via a secure point-to-point internet link from a semi-public database that is maintained by the prospective customer's existing telephone service provider; and
generating a sales proposal for an identical telephone service that is described in the customer service record.

17. The method of claim 16, where the computer server is accessed by a sales representative.

18. The method of claim 16, where the computer server is accessed by the prospective customer.

19. The method of claim 16, further comprising:
transmitting the sales proposal to the prospective customer via the internet.

20. The method of claim 16, further comprising:
transmitting the sales proposal to the prospective customer via facsimile.
